(19) United States
(12) Patent Application Publication
(10) Pub. No.: US 2026/0061328 A1
(43) Pub. Date: Mar. 5, 2026

(54) SYSTEM PROVIDING SKILL-BASED MATCHMAKING PROTOCOL AND LOW PLAYER LIQUIDITY OPTIMIZATIONS

(71) Applicant: Triumph Labs, Inc., San Francisco, CA (US)

(72) Inventors: Jacob Brooks, San Francisco, CA (US); Jared Geller, San Francisco, CA (US)

(21) Appl. No.: 19/311,208

(22) Filed: Aug. 27, 2025

Related U.S. Application Data
(60) Provisional application No. 63/687,670, filed on Aug. 27, 2024.

(51) Int. Cl. A63F 13/798

(52) U.S. Cl. CPC A63F 13/798

(57) ABSTRACT

The subject technology receives an online request from a first player to enter a game via a network. The subject technology determines a set of interoperable skill metrics of the first player, each interoperable skill metric corresponding to a different skill metric. The subject technology selects a particular interoperable metric from the set of interoperable skill metrics based on an analysis of prior game data of the game and an indication of a predictive performance of each interoperable skill metric. The subject technology performs a skill-based matchmaking process to match the first player to at least a second player based at least in part on the selected particular interoperable metric. The subject technology initiates an instance of the game for the first player and the second player.

### CROSS-REFERENCE TO RELATED APPLICATIONS

This application claims priority to U.S. Provisional Patent Application No. 63/687,670, filed on Aug. 27, 2024, entitled “SYSTEM PROVIDING SKILL-BASED MATCHMAKING PROTOCOL AND LOW PLAYER LIQUIDITY OPTIMIZATIONS,” and the contents of which are incorporated herein by reference in its entirety for all purposes.

### TECHNICAL FIELD

Embodiments of the disclosure relate generally to online competitive gaming and matchmaking techniques for games among multiple players.

### BACKGROUND

Online competitive games are video games that are played over the internet, where players or teams compete against each other to achieve a certain objective or high score. These games can range from simple puzzles to complex strategy games and fast-paced action or sports games. They are designed to provide a platform for competition, whether casual or professional, and often include features such as leaderboards, tournaments, and matchmaking systems to pair players of similar skill levels.

These games are popular for their ability to connect players from around the world, creating communities and fostering a competitive spirit. They often require a combination of individual skill, team coordination, and in-depth knowledge of the game mechanics to succeed.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a block diagram showing an example tournament system for facilitating online tournament gaming over a network.

FIG. 2 is a block diagram illustrating further details regarding the tournament system according to some embodiments.

FIG. 3 is a schematic diagram illustrating data structures associated with the tournament system, according to some embodiments.

FIG. 4 illustrates an example of an interface corresponding to a dashboard interface which is provided for display on a client device, in accordance with some embodiments of the subject technology.

FIG. 5 illustrates is a flowchart illustrating a method, according to some example embodiments.

FIG. 6 illustrates is a flowchart illustrating a method, according to some example embodiments.

FIG. 7 is a diagrammatic representation of a machine in the form of a computer system within which a set of instructions may be executed to cause the machine to perform any one or more of the methodologies discussed herein, according to some examples.

FIG. 8 is a block diagram showing a software architecture within which examples may be implemented.

### DETAILED DESCRIPTION

Skill-based matchmaking (SBMM) algorithms are used in online competitive gaming to pair players with and against others of similar skill levels, aiming to create fair and balanced matches. One goal of SBMM is to ensure that players have a challenging yet enjoyable experience, regardless of their skill level, by preventing matches where less experienced players are pitted against highly skilled players, which could lead to one-sided games.

SBMM is a feature in many online competitive games, including shooters, multiplayer online battle arenas (MOBAs), and sports games. SBMM can be a crucial technique(s) in the design of competitive online games to keep such games engaging and accessible to players of all skill levels.

Existing problems with some approaches of SBMM, in an example, scale considerably in games that allow real-time money wager. The subject system addresses technical challenges with SBMM in fiat money tournament systems as described further herein.

Some rigid matchmaking systems also lack the technical flexibility to adapt to different games and configurations without requiring bespoke solutions for each implementation.

For example, rigid skill-based matchmaking rules are usually utilized in individual games. A tournament system 100 as described further herein can work for any game, independent of the specific scoring mechanism the game employs, the distribution of entry prices that is utilized, and the configuration of the tournaments themselves. In order to do this, the tournament system 100 provides monitoring and observability techniques that enable skill-based matchmaking in a dynamic fashion. The tournament system 100 can perform (and modify) matchmaking at a per game configuration and user level as discussed further below.

Embodiments of tournament system 100 provide various skill-based matchmaking algorithms for a real-money tournament system that solves for low player liquidity constraints. Low player liquidity may refer to an insufficient numbers of active players within specific buy-in tiers or skill ranges to enable timely matchmaking, which can be characterized by match wait times exceeding predetermined thresholds or insufficient player populations to maintain competitive balance. With a limited number of players pᵢ for a skill-based game S, with entries of different buy-in amount bᵢ, tournament system 100 appropriately matches players with |pᵢ| small, such that a few properties are maintained: (i) players are matched with others at appropriate skill levels, (ii) players have fast match times, and (iii) players cannot exploit the matchmaking system to the detriment of other players and the entity running the system. Appropriate skill levels may refer to skill ratings that fall within predetermined threshold ranges as determined by the selected skill metric, where the difference between players' skill ratings satisfies a matching criteria for creating competitive and fair gameplay experiences. Fast match times may refer to the average time required to identify and pair suitable players, typically measured in seconds or minutes rather than the hours, days, or weeks experienced by other systems with limited player liquidity. Moreover, the tournament system 100 provides observability systems and real-time configuration to fine-tune skill matching to work for any game independent of its scoring mechanism and the specific tournament buy-in configurations.

As discussed further herein, tournament system 100 addresses specific technical challenges in computer-based skill-based matchmaking systems. Other SBMM approaches can suffer from player liquidity constraints, particularly at higher buy-in configurations, where insufficient player populations can result in match times extending to days or weeks while buy-in money remains locked in escrow. This creates a technical bottleneck that degrades system performance and user experience. Additionally, other systems may be vulnerable to exploitative behaviors where players can manipulate their skill ratings across different buy-in tiers, compromising the integrity of the matchmaking algorithms.

The technical approaches described herein therefore represent an advancement in computer-based gaming systems, providing concrete technological improvements that solve specific technical problems in online tournament platforms while maintaining system integrity and user experience quality.

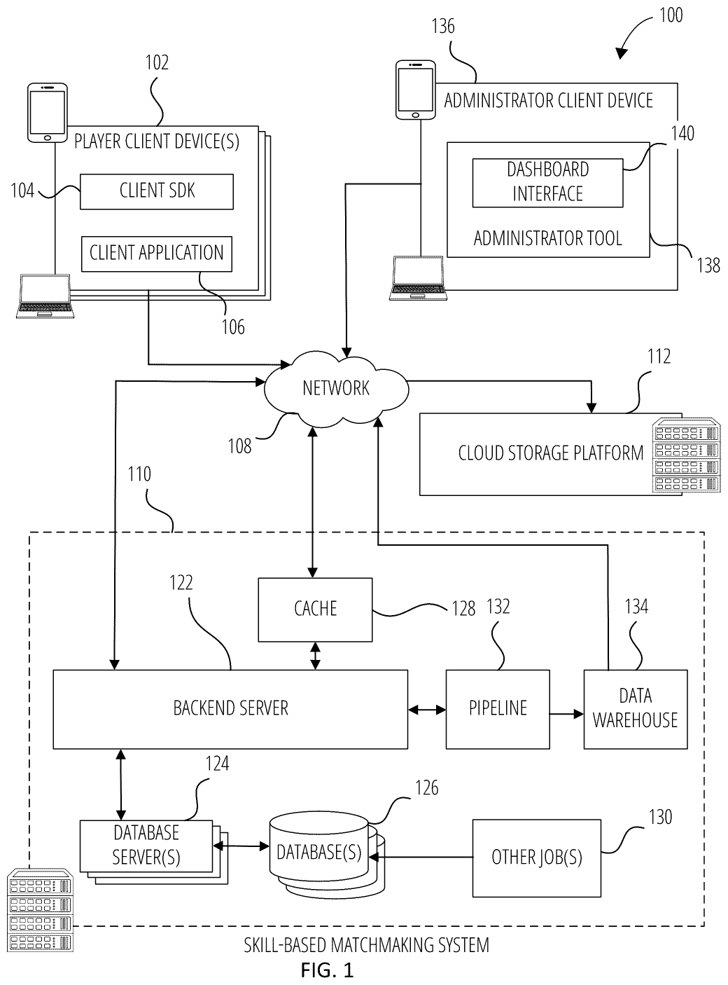

FIG. 1 is a block diagram showing an example tournament system 100 for facilitating online tournament gaming over a network. The tournament system 100 includes multiple player client devices 102, each of which hosts client application 106, including a client SDK 104. Each client SDK 104 is communicatively coupled, via one or more communication networks including a network 108 (e.g., the Internet), to at least a skill-based matchmaking system 110. A client SDK 104 can also communicate with locally hosted client application 106 using a set of applications program interfaces (APIs).

A player client device 102 may be a mobile device, tablet device, or a computer client device that are communicatively connected to exchange data and messages.

A client SDK 104 interacts with the skill-based matchmaking system 110 via the network 108. The data exchanged between the player client device(s) 102 and the skill-based matchmaking system 110 includes requests (e.g., commands to invoke functions) and payload data (e.g., text, audio, video, or other multimedia data), among other types of data.

In an example, client SDK 104 is included as part of the application code of client application 106. The code of the client application 106 can then call or invoke certain functions of the client SDK 104 to integrate features of the skill-based matchmaking system 110.

The client SDK 104 effectively provides the bridge between a particular resource (e.g., skill-based matchmaking system 110) and the client application 106 and other player client device(s) 102. This gives the user a seamless experience of communicating with other players or users while also preserving the look and feel of the client application 106. Messages or requests are sent between client application 106 and the skill-based matchmaking system 110 via communication channels asynchronously. In an example, a given SDK function invocation is sent as a message and callback, and an SDK function is implemented by constructing a unique callback identifier and sending a message with that callback identifier.

The client application 106 can provide an initial graphical user interface (e.g., a landing page or title screen) for a particular game(s) that a player or user can play. Moreover, client application 106 also provides another graphical user interface(s) that includes functions and features of the game, and an additional graphical user interface(s) for skill-based matchmaking system 110.

The skill-based matchmaking system 110 provides server-side functionality via the network 108 to the client SDK 104 on the player client device 102. While certain functions of the tournament system 100 are described herein as being performed by either a client SDK 104 or by the skill-based matchmaking system 110, the location of certain functionality either within the client SDK 104 or the skill-based matchmaking system 110 may be a design choice. For example, it may be technically preferable to initially deploy particular technology and functionality within the skill-based matchmaking system 110 but to later migrate this technology and functionality to the client SDK 104 where a player client device 102 has sufficient processing capacity.

The skill-based matchmaking system 110 supports various services and operations that are provided to the client application 106 of player client device 102. Such operations include transmitting data to, receiving data from, and processing data generated by client application 106 of the player client device(s) 102. Data exchanges within the tournament system 100 are invoked and controlled through functions available via user interfaces (UIs) of the client application 106, or though API calls from client SDK 104.

Turning now specifically to the skill-based matchmaking system 110, a backend server 122 provides programmatic interfaces, making the functions of the backend server 122 accessible to the player client device(s) 102, client application 106, administrator client device 136, and a cloud storage platform 112. The backend server 122 is communicatively coupled to a set of database server(s) 124, facilitating access to a set of database(s) 126 that each can store data associated with, or requested by, incoming requests processed by the backend server 122. Moreover, the backend server 122 can communicate with the cloud storage platform 112. Other job(s) 130 may access database(s) 126 including “chron” jobs (e.g., scheduled tasks or operations), and jobs related to post-processing, anti-fraud, and cleanup, among other types of jobs.

In an example, the backend server 122 can be hosted on a particular cloud service provider (e.g., AWS®, Google Cloud Platform®, Microsoft Azure®, and the like), and a cloud storage platform 112 can be provided on a particular cloud storage provider (e.g., AWS®, Microsoft Azure Blob Storage®, or Google Cloud Storage®, and the like).

In an example, the database(s) 126 are several different types of databases or storage platforms including, but not limited to, NoSQL, SQL database, and Google Cloud Storage®. Further, each such database from the database(s) 126 can store different data or information. For example, a first database can store profile photos, user logs, backups, and tournament replay videos. A second database can store user objects, skill metrics, balance transactions (e.g., any change in money), remote configuration features, and game parameters. A third database can store a matchmaking table indicating games that are waiting to match along with skill thresholds (discussed further herein). It is appreciated that the aforementioned databases are examples, and any of the aforementioned data can be stored on a different or another database(s) for any appropriate database platform or any type of database model.

In an embodiment, a cache 128 and backend server 122 process incoming network requests from the player client device 102 over the Hypertext Transfer Protocol (HTTP) and other related protocols. As shown, the cache 128 is coupled to the backend server 122. In an implementation, the cache 128 is a web cache that temporarily stores data including web documents, such as HTML pages and images, to reduce bandwidth usage, server load, and perceived lag. Such a web cache stores copies of documents and data passing through it; subsequent requests for the same document or data may be served from the cache 128. In the event that there is a cache miss (e.g., the requested document or data is not currently stored in the cache), the cache 128 forwards such a request(s) to the backend server 122 for processing.

As further shown, a pipeline 132 periodically receives data from the backend server 122, which is forwarded to a data warehouse 134. In turn, the data warehouse 134 can forward the data to the cloud storage platform 112 for storage or send the data directly to the administrator client device 136. In this regard, the administrator client device 136 can query the cloud storage platform 112 for data, or alternatively, receive data directly from the data warehouse 134. The pipeline 132 may be implemented as an ETL (Extract, Transform, and Load) pipeline extracting data from the backend server 122, transforming such data to fit operational needs, business rules, or compliance requirements, and then store the data onto the data warehouse 134. “Data warehouse” refers to a centralized repository of integrated data from one or more sources (e.g., the backend server 122). The data warehouse 134 stores current and historical data, for example, that is utilized for creating analytical reports by an administrator tool 138, in which such reports may be provided for display on a dashboard interface 140.

The cache 128, coupled to the backend server 122, is provided for reducing latency, and the pipeline 132 that processes data through the ETL to the data warehouse 134 provides a technical architecture that enables sub-second matchmaking decisions while maintaining data integrity across distributed cloud storage platforms.

In an embodiment, the backend server 122 provides a set of interfaces (e.g., routines and protocols) that can be called or queried by the client SDK 104 to invoke the functionality of the backend server 122. The backend server 122 exposes various functions that can be invoked by the client SDK 104, including account registration; login functionality; the sending of data, via the backend server 122, from a particular player client device 102 to a different player client device 102; the communication of media files (e.g., images or video) from a client SDK 104 to the backend server 122; the retrieval of messages and content; and application event(s) (e.g., relating to the client SDK 104).

In an implementation, the administrator client device 136 provides an administrator tool 138 that provides a set of (e.g., web-based or application-based) interfaces including at least the dashboard interface 140, among other types of interfaces. For providing real-time metrics and analytics for a game to a given developer (e.g., one that created the client application 106), the administrator client device 136 includes the administrator tool 138, which provides the dashboard interface 140. The administrator tool 138 communicates with the data warehouse 134 to receive data including analytics and metrics with respect to the game provided by the developer. Moreover, reporting information related to transactions and financial data is provided from the data warehouse 134 to the administrator tool 138 running on the administrator client device 136.

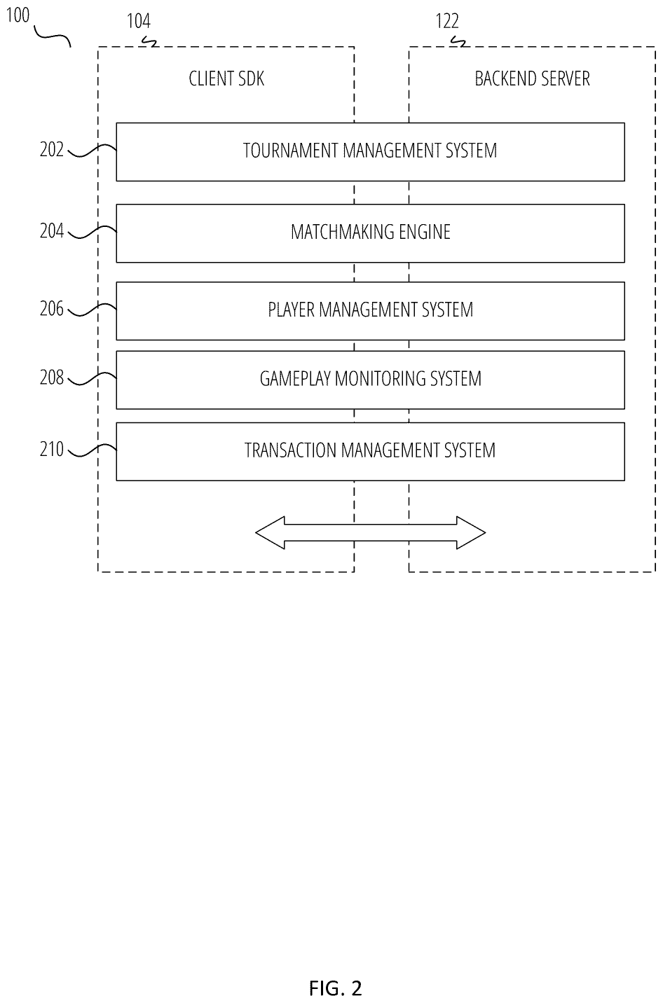

The backend server 122 hosts multiple systems and subsystems, described below with reference to FIG. 2.

FIG. 2 is a block diagram illustrating further details regarding the tournament system 100 according to some embodiments. Specifically, the tournament system 100 is shown to include the client SDK 104 and the backend server 122. The tournament system 100 includes a number of subsystems, which are supported on the client-side by the client application 106 and on the server-side by the backend server 122. These subsystems include, for example, a tournament management system 202, a matchmaking engine 204, a player management system 206, a gameplay monitoring system 208, and a transaction management system 210.

In some examples, the tournament system 100 may employ a monolithic architecture, a service-oriented architecture (SOA), a function-as-a-service (FaaS) architecture, or a modular architecture. Example subsystems are discussed below.

Referring to FIG. 2, the system 100 is shown to include a tournament management system 202 that is responsible for receiving requests or data from the client SDK 104 on each of the player client devices 102, the client application 106 executed by each of the player client devices 102, the cache 128, and the cloud storage platform 112.

The tournament management system 202 is also responsible for exporting data to each of the player client devices 102 and client SDK 104 or between the systems in the tournament system 100. The tournament management system 202 is also configured to manage the third-party integration of the functionalities of the tournament system 100 (e.g., via the client SDK 104 being integrated in the client application 106 on the player client device 102).

Further, the tournament management system 202 can modify or set parameters such as tournament entry fees and prize structures. In addition, the tournament management system 202 sets and manages in-game marketing parameters such as deposit inducement payments or additional bonus prizes/awards. Using the dashboard interface 140, a developer (or user) can adjust or set the aforementioned parameters.

In an example, the tournament management system 202 provides a remote configuration architecture that enables real-time parameter adjustment across global, game, and user levels. The subject system performs a hierarchical read operation sequence: first reading a global configuration object, then a game-level configuration object, and finally a user-level configuration object, with each subsequent level overwriting matching parameter fields from higher levels. This technical approach enables a dynamic system optimization without requiring software updates or system restarts, providing a technological improvement over static configuration systems.

In an implementation, the client SDK 104 provides controls for implementing, managing, and setting the parameters of both: (i) the real-cash entry fees; and (ii) the prize structures obtained in a tournament. As mentioned herein, a “tournament” refers to a single game that, when the completion conditions are met, results in a distribution of prizes in accordance with a preset (and disclosed prior to entry by the entrants) prize structure to the entrant(s) in that tournament.

The matchmaking engine 204 is responsible for performing techniques for matchmaking between players of a particular game (e.g., different users of each client application 106 executing on each player client device 102).

In an example, the matchmaking engine 204 implements a cross-buy-in matching algorithm that addresses the technical liquidity problem by allowing players with different buy-in amounts to be matched while maintaining mathematical fairness constraints.

The player management system 206 manages features for players or users (e.g., using client application 106) of a game (e.g., the client application 106) including viewing account balances, deposit and withdrawal history, tournament history including scores, entry fees, and prizes won. Additionally, players can make withdrawals or deposits and enter tournaments from within the client application 106.

In addition, the player management system 206 manages the players with a goal of creating an environment that maximizes gameplay. For example, the client SDK 104 provides automated software functions and protections to reduce payment fraud, card reversals, cheating, and to increase fairness in the games. In the event that there is an indication of fraud or cheating, player behavior can be monitored through the SDK interactions with client SDK 104 and responses to the backend server 122 to determine if any circumvention occurs. If so indicated, the player management system 206 facilitates suspending the player account and enables 1) following up through a video or phone call with the user or 2) instituting a permanent ban of the account, which disallows any further accounts using either the name, phone number, or that device from accessing the tournament system 100.

The client SDK 104 provides an integration layer that enables seamless tournament functionality within existing game applications without requiring users to exit the game environment. In an example, the client SDK 104 handles complex regulatory compliance, payment processing, and matchmaking operations while maintaining the native look and feel of the host application. This technical approach enables providing a unified platform that can be integrated into any compatible game software.

The gameplay monitoring system 208 enables real-time visibility on an individual game basis. In an example, if a developer has created two games, the gameplay monitoring system 208 provides all data relevant to each game, which can be viewable separately (e.g., using the dashboard interface 140). Both gameplay and financial data are monitored, tracked, and displayed in real-time in the dashboard interface 140, making it useful for both the management of in-game interactions, marketing, and updating for player retention as well as providing audit-ready financial data.

The gameplay monitoring system 208 tracks information relevant to a game, its marketing, and user interactions. In an example, such information includes data related to active users, user retention statistics, and transaction data. Using such information, the dashboard interface 140 can provide for display where most of the value is generated, e.g., the tournaments and the amount played and the fees collected by each game, tournament type, and user. The dashboard interface 140 can present this information on both a granular transaction level and in the aggregate over a (developer selected) period of time.

In an example, the gameplay monitoring system 208 implements automated stabilizers that perform system health checks every minute, monitoring both absolute trailing profit over twenty-four hour periods and percentage profit on each game configuration. When predetermined thresholds are exceeded, the gameplay monitoring system 208 automatically alerts relevant personnel and can autonomously disable specific games, game modes, or configurations to prevent system degradation. This technical implementation provides automated risk management that operates independently of human intervention, solving the technological challenge of maintaining system stability across millions of daily transactions.

The transaction management system 210 allows the developer to avoid complex regulatory and payment processing issues. In addition, the transaction management system 210 is responsible for the funds deposited and the player and developer accounts. Thus, the developer has real-time access (e.g., via the dashboard interface 140) to relevant transaction and gameplay data and also the ability to withdraw or deposit funds as needed directly from the tournament system 100.

The transaction management system 210 monitors ancillary transactions relevant to the game developers, including the crediting of the developer account for tournament fees, the debiting of that account for any directly awarded tournament prizes, the assessment of platform fees for the tournament system 100, and the use of in-game marketing mechanisms such as cash or bonus cash. In an example, bonus cash is a player account credit denominated in dollars that: (i) is used after all real cash has entered a tournament; (ii) must be used prior to withdrawal; and (iii) if not used prior to withdrawal, is cancelled upon a withdrawal of real cash.

Using at least the information provided from the transaction management system 210, the dashboard interface 140 includes all payment processing actions and in-game transactions related to players and game developers. For example, the dashboard interface 140 presents information related to deposits, withdrawals, tournament entry fees and starts, tournament finishes and prizes awarded, debiting of player accounts for entries, and crediting of player accounts for prizes or deposits.

Transactions affecting the developer account are viewable on a granular level in the dashboard interface 140. For example, the entry of two players into a $1 tournament with a $0.20 fee would be presented as two $0.20 credits to the developer account and where the date, time, user, and game from which such credits arose are identified.

The dashboard interface 140 also enables viewing transaction and user data in the aggregate over a selected period of time to provide a developer (or administrator, and the like) with a set of data on which to base decision making. Further, the developer can withdraw funds, using the dashboard interface 140, and deposit any funds needed for in-game marketing or any other appropriate purpose.

The following discussion relates to aspects of real money (e.g., fiat) gaming that are addressed by components and subsystems of the tournament system 100.

Real money games need a large daily active user count (DAU) to support skill-based matchmaking, especially at higher buy-in configurations. A “buy-in” for a tournament involving money refers to the entry fee that a participant must pay to enter the competition. This fee contributes to the prize pool, which will be distributed to the winners according to the tournament's prize structure, and may also cover the costs of organizing the event.

In an example, suppose a game S offers real money tournaments with entry prices {pᵢ} to win a prize of (2pᵢ−fᵢ), where fᵢ is the tournament provider's fee associated with a given buy-in tournament. Nearly all such games suffer from the same issue: there are not enough players at the higher pᵢ entry prices to appropriately match players. This can lead to match times taking days or weeks, which hampers the player experience and prevents further play while the buy-in money is locked in escrow. Moreover, there is an inherent tradeoff between matchmaking speed and matchmaking quality. If worse quality matchmaking is allowed, faster speeds (i.e., better player liquidity) can be achieved, and visa-versa. However, this is not a desirable solution, because players want the fairest experience possible when there are high stakes (e.g., money being involved).

In some instances, players attempt to exploit SBMM algorithms when real money is involved. Such exploits can take various forms including purposefully doing poorly on a lower buy-in match, and then preforming well on higher buy-in games or creating multiple accounts to reset one's skill level. This is unfair for all players involved and hampers the integrity of a real money system (e.g., the tournament system 100).

The following discussion relates to cross-buy-in matchmaking that allows players with different buy-in amounts to be matched against each other while maintaining predetermined prize structures for each player.

In some existing systems, separate liquidity pools are created for each buy-in threshold for a given game. Those wagering a given amount will always be matched with each other. The intention here makes sense: host different tournaments, with different buy-ins, and match players within these tiers.

A key insight behind the SBMM utilized by the matchmaking engine 204 is that there is no requirement for matching two players at the same exact buy-in configuration level, as long as the contract offered to players is honored, namely, that if they win a game where they wagered an amount bᵢ, they will win the predetermined prize of (2bᵢ−fᵢ). It is not necessary that this is the same for each player. For example, if player p_{A} and player p_{B} have sufficiently similar skill (discussed further below), and p_{A} is playing a game for an amount b_{A} and PB is playing a game for b_{B}, in the case p_{A} wins, p_{A} will get (2b_{A}−f_{A}), while if p_{B} wins, PB will get (2b_{B}−f_{B}). As a result, a total profit (π) on this match is represented by the following:

$$π = \{ \begin{matrix}( {b}_{A} + {b}_{B} ) - ( 2 {b}_{A} - {f}_{A} ) & if {p}_{A} wins \\ ( {b}_{A} + {b}_{B} ) - ( 2 {b}_{B} - {f}_{B} ) & if {p}_{B} wins\end{matrix}$$

It is noted that π for an individual game can be negative, namely, if the higher buy-in player wins (and assuming fᵢ is not sufficiently large, which is the case in practice). However, the matchmaking engine 204 can assume that P (p_{A} wins)=P (p_{B} wins)=0.5p; then an expected profit on a given match is represented in the following:

$$P ( π ) = ( 0.5 ) [ ( {b}_{A} + {b}_{B} ) - ( 2 {b}_{A} - {f}_{A} ) ] + ( 0.5 ) [ ( {b}_{A} + {b}_{B} ) - ( 2 {b}_{B} - {f}_{B} ) ]$$

$$= ( {b}_{A} + {b}_{B} ) - ( {b}_{A} - {b}_{B} ) + ( 0.5 ) {f}_{A} + ( 0.5 ) ( {f}_{B} )$$

$$= ( 0.5 ) ( {f}_{A} + {f}_{B} ) .$$

Assuming a sufficient number of matches (e.g., based on a first threshold), over a long period of time (e.g., based on a second threshold), the tournament management system 202 collects the average of the fees of all of the tournament configurations. In an example, an expected long period of time profit is represented by the following:

$$E [ π ] = \overline{f} n$$

Where n is the number of games played for the above.

The average fee over all buy-in configurations is represented by the following:

$$\overline{f} = \sum {f}_{i} / \vert f \vert$$

In a worst case analysis scenario, the matchmaking engine 204 only allows buy-in ranges to match within a certain threshold, rather than across the entire buy-in space. B and B* are defined to be dollar and percentage thresholds on the maximum buy-in difference, respectively. In this example, a match is performed if and only if:

$$the absolute buy in difference \vert {b}_{A} - {b}_{B} \vert \leq B$$

$$or ( assuming {b}_{A} < {b}_{B} without loss of generality )$$

$$\frac{{b}_{A} - {b}_{B}}{{b}_{B}} \leq B *$$

For example, if B=10 and B*=0 then the matchmaking engine 204 would allow a $5 game to match with a $15 game, but not allow a $5 game to match with a $16 game. In this example, a per game loss would be ($25+f), which lowers the variance of a potential downside. However, player liquidity may be impacted. In the context of SBMM, “player liquidity” refers to the availability and flow of players within the matchmaking pool at any given time. High player liquidity means that there is a large number of players actively seeking matches, which allows the matchmaking engine 204 to create games more quickly and with more accurately matched opponents in terms of skill level.

The matchmaking engine 204 creates a “player liquidity curve,” which is a function f (B)=W_{avg} where W_{avg} is the average time it takes a player to find a match. This curve enables optimization of the trade-off between matchmaking speed and quality by providing quantifiable metrics for system performance across different threshold settings. In an implementation, the matchmaking engine 204 monitors and adjusts B and B* carefully, and has the ability to set these thresholds as a function of DAU (daily active users), confidence in skill metrics, and based on a number of active tournaments in a game's liquidity pool. Essentially, the trade-off between player liquidity and quality of SBMM can be avoided by introducing a way to increase matchmaking speed. Moreover, the matchmaking engine 204 also handles scenarios when there are exponentially fewer games at the highest buy-in configurations than the lowest configurations, thereby resolving a potential player liquidity problem. In an example, the subject system can reduce average match times from days or weeks as experienced in other systems to sub-minute matching thereby improving the performance and technical functionality of the subject system.

The following discussion relates to confidence intervals and distributional properties.

Assuming normality in the distribution of games, the matchmaking engine 204 can construct confidence intervals of a worst case scenario analysis given these thresholds. For the purpose of simplicity, it is assumed B*=0, although a similar analysis follows via constraining this variable as well.

In an example, the matchmaking engine 204 constructs confidence intervals on a distribution of the following random variable:

$$random variable V = {\sum }_{i} {π}_{i}$$

$$for large i where {π}_{i} are the results of match - ups$$

$$with the constraint \vert {b}_{A} - {b}_{B} \vert \leq B$$

In this example, b_{A} and b_{B} are random integers under the constraint |b_{A}−b_{B}|<B that differs per tournament, and f_{A} and f_{B} are also random integers without additional constraints.

The random variable x is defined as:

$$π = \{ \begin{matrix}( {b}_{A} + {b}_{B} ) - ( 2 {b}_{A} - {f}_{A} ) & if {p}_{A} wins \\ ( {b}_{A} + {b}_{B} ) - ( 2 {b}_{B} - {f}_{B} ) & if {p}_{B} wins\end{matrix}$$

Under the constraint |b_{A}−b_{B}|<B, the variability of b_{A} and b_{B} is reduced, impacting the distribution of X. Namely, if p_{A} wins, X=b_{B}−b_{A}+f_{A} and if p_{B} wins X=b_{A}−b_{B}+f_{B}. As B decreases, the variability in the outcomes of X is reduced. Specifically, when B=0, the random variable X becomes deterministic as b_{A}=b_{B}, leading to a profit of just the sum of fees. The specific variance calculations depend on the assumed distribution of the aforementioned parameters. Variance has been lowered by providing buy-in thresholds that can be adjusted per game (and per player,), in real time (e.g., using the tournament management system 202).

The following discussion relates to skill-based matchmaking to prevent exploitative behavior.

The matchmaking engine 204 uses multiple SBMM algorithms that are used in tandem to provide a skill score S that is used to match within different buy-in constraints, as discussed above. With respect to differentiating between SBMM algorithms and metrics, a given SBMM algorithm is a mechanism to provide SBMM, while a metric is a specific number or function attached to each user that is a parameter the SBMM algorithm uses to create a match. In an implementation, one SBMM algorithm as discussed herein utilizes many interoperable metrics.

Each skill metric is computed for every user. The following discussion relates to all skill metrics that are used, and includes a description of how the skill metrics are used in tandem in a SBMM algorithm.

The following discussion relates to dollar-weighted average score with discount rate.

In mathematics, “weighting” refers to the process of assigning different levels of importance to various elements within a set of data or to different components of a mathematical calculation. In an example, weighting (or “weighted” when referring to the weighting already been performed, or “weights” as a verb when, e.g., being performed by the matchmaking engine 204) is performed by multiplying the elements by a factor that represents their relative importance, known as a “weight.”

The first skill metric is the simplest: taking a user's average score, weighted by dollar amount. For example, a player p scores {s₁, s₂, . . . , sₙ} over time, for tournaments with buy-ins {b₁, . . . , bₙ}. The naive weighted average score is computed as the following:

$${w}_{avg} = \frac{{\sum }_{i = 1}^{n} {s}_{i} {b}_{i}}{{\sum }_{i = 1}^{n} {b}_{i}}$$

Using the above, the matchmaking engine 204 weights players' scores for higher buy-in games relatively more, such that a player cannot tank this score purposefully to get easier matches when they decide to play a higher game.

The matchmaking engine 204 also computes this dollar-weighted average score with a discount rate r, which weights more recent games more strongly. In an example, this is computed based on the following:

$${w}_{avg} = \frac{{\sum }_{i = 1}^{n} {s}_{i} {b}_{i} {r}^{( n - i )}}{{\sum }_{i = 1}^{n} {r}^{( n - i )} {b}_{i}}$$

In an example, Sᵢ represents individual game scores, bᵢ represents corresponding buy-in amounts, r is the discount rate factor (typically close to 1), and n is the total number of games played, with more recent games receiving higher weighting through the discount rate factor. This weighted factor is close to 1 and differs per game.

This skill metric is suitable for single-player game modes. When there is no opponent, it is not feasible to use an adversarial skill metric like Elo (whose updates depend on the opponent's score).

The metrics, as discussed below, are applicable to groups of players, and therefore are more suitable to head-to-head tournaments and matchmaking within the tournament system 100.

The following discussion relates to binary weighted Elo. As mentioned herein, in general, the Elo rating system assigns a numerical value to players based on their performance against other players. If a player wins against another player with a higher rating, the player gain more points than if the player wins against yet another player with a lower rating. Conversely, losing to a player with a lower rating results in a larger loss of points.

Suppose p_{A} has Elo e_{A} and p_{B} has Elo p_{B} and have a game. The matchmaking engine 204 can update the players' via the following operations. First, the matchmaking engine 204 computes the “expected score” post-match for each player, as follows:

$${E}_{A} = \frac{1}{1 + {10}^{\frac{{e}_{B} - {e}_{A}}{D}}}$$

$${E}_{B} = \frac{1}{1 + {10}^{\frac{{e}_{A} - {e}_{B}}{D}}}$$

where D is a constant, which historically is defaulted to 400.

Next, the matchmaking engine 204 assigns a “score” value Sᵢ of 1 to the winner and 0 to the loser. If the players tie, the matchmaking engine 204 assigns both players a score Sᵢ of 0.5. The matchmaking engine 204 updates values for Elo as shown in the following:

$${elo}_{A} = {elo}_{A , prev} + K * ( {S}_{A} - {E}_{A} )$$

$${elo}_{B} = {elo}_{B , prev} + K * ( {S}_{B} - {E}_{B} )$$

where K is a constant called the “K-factor”. The K factor represents the “speed” at which players' scores update. The K factor can vary over time, decreasing as a function of the number of games played (with a minimum of 15).

The matchmaking engine 204 employs a custom-defined skill metric, called “binary weighted Elo,” which works as follows: keep track of a player's Elo for all their practice (free) games, e_{f} and paid games eₚ. In an example, as defined, the binary weighted Elo e_{b}=max (e_{f}, eₚ). In this example, e_{f} represents a player's Elo rating calculated from free practice games and eₚ represents their Elo rating calculated from paid tournament games, with the subject system using the maximum value to prevent manipulation through poor performance in free games.

This metric e_{b} is a suitable metric to use in matchmaking, because this metric is based on the assumption that players try (e.g., provide more effort to be competitive) on paid games, even though they may not try (e.g., provide less effort to be competitive) on free games. Metric e_{b} assumes, however, that once money is on the line, a player will try as hard (e.g., provide a higher amount of effort) as they can. Further, players who do not know how the tournament system 100 works, and try to tank (e.g., lose purposefully) games, will generally do so on the free games, which will not impact e_{b}. Thus, e_{b} provides a balance of simplicity while also preventing the most obvious malicious attempts to use weighting to a players' advantage.

However, a more complex weighting system weights games according to their buy-ins respectively, which is discussed in the following paragraphs.

The following discussion relates to an example ladder weighted Elo.

This metric is a variation of the previously discussed binary weighted Elo. Rather than having simply a free Elo and a paid Elo, a map of Elos for each user at each buy-in configuration is provided. For example, if offering buy-ins for a game {p₁, p₂, . . . , pₙ}, then an Elo metric for each pᵢ per player is recorded. Let E_{p,i} represent the Elo for a player i at price p, and suppose player A enters a game for p_{A} and player B matches that player with a buy-in of p_{B}. Thus, the ladder-weighted Elo metric can maintain separate Elo ratings for each buy-in price level, where E_{p,i} represents the Elo rating for player i at price level p, and the subject system updates all Elo ratings at or below a player's current buy-in level after each match to prevent skill manipulation across different monetary tiers.

The maximum Elo for player i at any buy-in is less than what the player paid for the current match, which can be represented by the following:

$${H}_{i} = max \{ {E}_{p , i} \vert ∀ p \leq {p}_{i} \}$$

After a match, the matchmaking engine 204 updates the players' Elo maps via the following rule: update all of player j's Elos in the map where p≤pⱼ using Hₒₜₕₑᵣ player as the opposing players' Elo. This ensures players cannot game (e.g., compromising the integrity of the matchmaking algorithm) the system by, purposefully, performing poorly on a low buy-in match and then trying with more effort on a higher wager match. It also ensures that there is sufficient data to give accurate skill matching. In an example, only the Elo for the individual price configuration a player chooses is updated, and then a player is initialized to the default Elo whenever that player plays a new match tier. In this example, where |{p₁, . . . , pₙ}| is large, this would be infeasible. Updating all lower buy-in configurations also follows an assumption that players will, in general, try harder when they wager more.

The following discussion relates to weighted Elo.

The matchmaking engine 204 can weight Elo formulas in a variety of ways; however, doing so naively can destroy properties of Elo that one cares about the most, namely, ensuring that the distribution of a population of Elo scores are normal. For example, techniques can be used to simply weight the K factor by the buy-in amount, or some transformation of the buy-in amount (e.g. √b). However, such techniques can destroy the normality properties that make Elo a standard metric in the competitive gaming industry. In an example, without normality, the matchmaking engine 204 may not create confidence intervals, nor know the variance of Elos (except empirically), and therefore it becomes complex to set matchmaking parameters appropriately.

In an implementation, the matchmaking engine 204 determines an Elo variant that weights the importance of a game via its buy-in, while maintaining the same distributional properties of normal Elo. For example, the matchmaking engine 204 calculates the “spread” that the normal Elo formula would give, and then distributes this spread according to the relative buy-ins of players.

Suppose p_{A} and p_{B} are players who paid b_{A} and b_{B} respectively to play. The matchmaking engine 204 calculates C_{A}=Δelo_{A} and C_{B}=Δelo_{B}, the expected change in Elo for each player under the naive Elo formula. Now, the matchmaking engine 204 computes the real updates for each player ARA, ΔR_{B} as follows:

$$Δ {R}_{i} = \frac{( {C}_{i} {b}_{i} ) {\sum }_{k ∈ \{ a , b \}} \vert {C}_{k} \vert}{{\sum }_{k ∈ \{ a , b \}} \vert {C}_{k} {b}_{k} \vert}$$

This ensures the spread of Elos are not unbounded, and keeps the normality conditions. By way of example, let elo_{A}=1600, elo_{B}=1800, b_{A}=2, b_{B}=1. In this example, player A wins. The expected Elo change for p_{A} would be the following:

$$K * ( {S}_{A} - {E}_{A} ) where {S}_{A} = 1 and {E}_{A} = \frac{1}{1 + {10}^{\frac{{e}_{B} - {e}_{A}}{D}}}$$

meaning the player's Elo would change by 15*(1−0.24)≈11.4, while similarly, p_{B}'s Elo would change by −11.4.

However, the change in weighted Elo would be the following:

$${R}_{A} = \frac{( 22.8 ) ( 22.8 )}{( 11.4 ) ( 2 ) + ( 11.4 ) ( 1 )} = 15.2$$

$${R}_{B} = \frac{( - 11.4 ) ( 22.8 )}{( 11.4 ) ( 2 ) + ( 11.4 ) ( 1 )} = - 7.6$$

Notice how in the original Elo formula, a total of 22.8 points are exchanged between the players. This is still true in the weighted Elo discussed above; however, p_{A} gets a greater share of the change, since this player had relatively more at stake. It can be determined that p_{A} received exactly ⅔ (two-thirds) of the change in Elo, which represents the fact that p_{A} contributed ⅔ (two-thirds) of the total buy-in share.

Thus, it can be ensured that the spread of Elo from a given game remains the same, but that spread is allocated accordingly to the relative buy-in share of the players. For equal buy-ins, this will default to the standard Elo formula. In these techniques, allocate matchmaking engine 204 still uses the maximum of this Elo and free Elo, as free games do not work under such matchmaking techniques (e.g., they will always have 0 Elo adjustment, since the other party is contributing the full buy-in).

The following discussion relates to Elo K factor reduction.

The matchmaking engine 204 employs a technique to decrease a player's K factor in Elo calculations over time. The matchmaking engine 204 uses the following step-wise function:

$$K ( n ) = \{ \begin{matrix}40 & if n \leq 5 \\ 30 & if n \leq 15 \\ 20 & if n \leq 30 \\ 15 & if n \leq 50\end{matrix}$$

where n is the number of games a player has played (this is computed separately for free and paid games).

The matchmaking engine 204 configures this function on a per game level, depending on how quickly or slowly it is expected that players adjust to their true game skill.

The following discussion relates to interoperability and remote configurability of the tournament system 100.

The tournament management system 202 keeps track of all of these skill metrics for each player/game. The matchmaking engine 204 can select which metric makes the most sense to use for matchmaking based on analyzing previous game data and discovering each metrics' predictive performance. The matchmaking engine 204 can match games via any metric, and provides a remote configurable functionality to have the ability to change which metric to use, such that these parameters can be changed on a per game and on a per user level. For example, the matchmaking engine 204 uses the aforementioned SBMM algorithm that matches people at lower skill levels using, for example, weighted average score, while the matchmaking engine 204 can match people at higher skill levels using Elo, or the matchmaking engine 204 can use a different metric altogether for different games.

The gameplay monitoring system 208 monitors all matches in the subject system, providing information to the matchmaking engine 204, and the matchmaking engine 204 may choose to move games/players between various matchmaking metrics with various parameters to measure impact on the quality of matchmaking.

In an implementation, real-time web-socket connections to the database(s) 126 are utilized. A global schema is provided, which enables a remote configurable feature for various parts of the tournament system 100, including the matchmaking engine 204. Each feature has the schema, which can be represented as in the following:

```
{
  “uid”: “matchmaking” //unique identifier
  “version” : “1”, // version to use
  “disabled”: false // disable
or enable feature
  “metadata” : {
  “B_star” = 0,
  “B”: 5,
  “metric”: “welo”
  } // various
parameters for the specific feature
}
```

In an example, the tournament management system 202 will look for this schema in a top-level global collection in the database(s) 126, on an individual game level, and then on an individual user level, and merge these values together (in that order of priority). For example, if the tournament management system 202 sets a user's matchmaking feature to disabled, that user will not be able to enter matches even though the game and global levels have the feature enabled. The following is an example set of operations that are performed in this regard:

| 1. | Read remote |
|---|---|
| configuration object for feature F from global | |
| 2. | Read remote configuration object for feature F |
| from game. Overwrite matching fields if they exist. | |
| 3. | Read remote configuration object for feature F |
| from user. Overwrite matching fields if they | |
| exist. | |
| 4. | Return feature schema |

This feature JSON is read before every game is entered, to ensure that the tournament management system 202 can make real-time adjustments to the parameters. This can enable sub-second parameter adjustment capabilities of the subject system compared to other systems that (may frequently) require software updates and perform a slower parameter adjustment process. The tournament management system 202 stores the feature metadata on the tournament object for each user so the matchmaking engine 204 only matches people within appropriate metrics (for example, the matchmaking engine 204 does not match people where the metric metadata differs between users). The tournament management system 202 does this by reading the metadata into a SQL query that finds appropriate matches and filtering on the metric being the same. In an example, a remote configuration object may refer to a data structure comprising fields for a unique identifier, version number, feature enable/disable status, and metadata containing parameters specific to a feature, organized hierarchically at global, game, and user levels with higher priority levels overwriting matching parameter fields from lower priority levels. The following discussion relates to profit analysis.

In an implementation, the matchmaking engine 204 defines the matchmaking fee M of a given match between p_{A} and p_{B}, each with buy-ins b_{A}, b_{B} and listed fee f_{A}, f_{B}, to be the total profit on a given tournament less the implied fees, or M=π_{match}−f_{A}−f_{B}.

In an implementation, the tournament system 100 can be entirely at risk-off if the fees cover the worst case analysis matchmaking fee. For example, if all fees are set at ten percent of the buy-in, i.e., a $1 game has a 10 cent fee, the tournament management system 202 can set the threshold B* to be 10 percent, and in the worst case scenario, the tournament system 100 will break even on a game.

The following discussion relates to automatic stabilizers.

With millions of games a day, watching the matches in real time is not sufficient. In an implementation, the tournament management system 202 provides a system health check that runs every minute that checks: (i) the profit/loss of the matchmaking, and (ii) adjusts the parameters appropriately. For example, the tournament management system 202 monitors on a per game (and per configuration) basis (i) the absolute trailing profit over a twenty-four hour basis, and (ii) the percentage profit on each game/configuration over a twenty-four hour period. If at any time the thresholds are met, the tournament management system 202 will provide an alert (e.g., to all relevant employees of the tournament system 100) and, if they pass a critical threshold, the tournament management system 202 shuts off various games/game mode(s), or configuration(s) of the system.

### Data Architecture

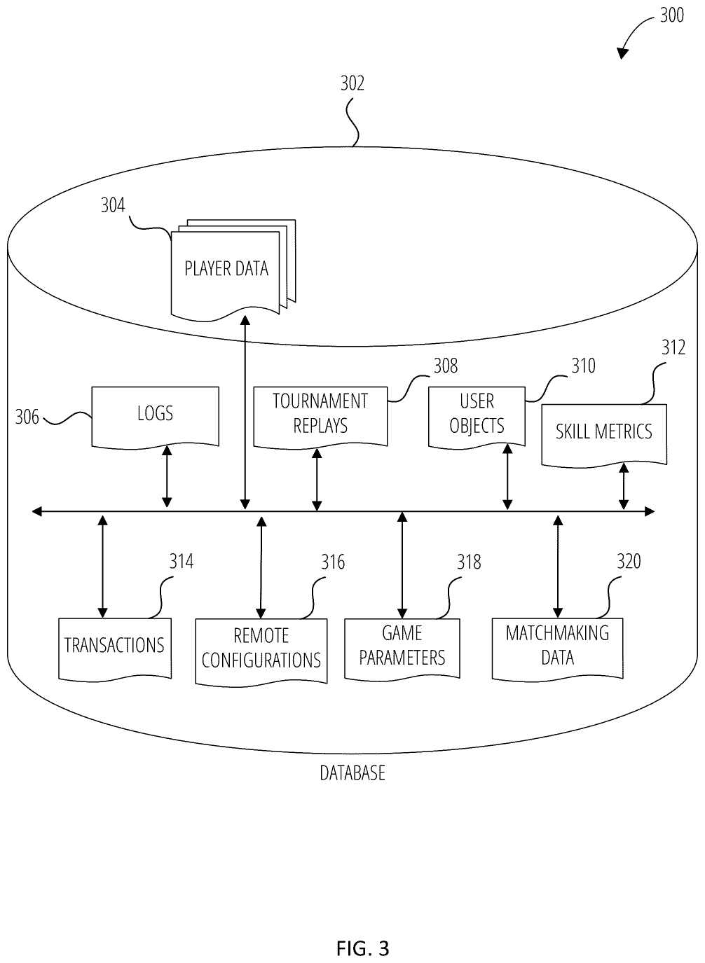

FIG. 3 is a schematic diagram illustrating data structures 300 associated with the tournament system 100, which may be stored in the database 302 of the skill-based matchmaking system 110, according to some embodiments. While the content of the database 302 is shown to include a number of tables, it will be appreciated that the data could be stored in other types of data structures (e.g., as an object-oriented database, a key-value store, and the like). In an embodiment, the database 302 may be part of the set of database(s) 302 provided by the skill-based matchmaking system 110. However, in an alternative embodiment, the database 302 may be stored on the player client device 102.

In an example, the database 302 stores specialized data structures for real-time matchmaking operations, including dedicated tables for player data 304, logs 306, tournament replays 308, user objects 310, skill metrics 312, transactions 314, remote configurations 316, game parameters 318, and matchmaking data 320.

The player data 304 stores profile data for each player. For an individual, the player data 304 includes, for example, a user name, telephone number, address, settings (e.g., notification and privacy settings), as well as a user-selected or system-provided avatar representation (or collection of such avatar representations) or profile photo(s). In an example one or more of these avatar representations or profile photo are included within the content of messages communicated via the tournament system 100, and on interfaces displayed by on each player client device 102 to other users.

The logs 306 store user logs corresponding to records that capture various types of information related to a player's activities and interactions within a game. The specific data stored in user logs can vary depending on the game's design, the information the developers wish to track, and privacy considerations.

The tournament replays 308 store media that can be in the form of a video reconstructing a player's gaming session in a particular game. In an example, the player's session starts when the user arrives in the game and ends upon the user's exit from the game.

The user objects 310 store object data related to each user (e.g., player) of tournament system 100. Such object data can facilitate matchmaking by matchmaking engine 204 in the manner(s) described before.

The skill metrics 312 store data related to skill metrics as discussed herein.

The transactions 314 store data related to transactions that occur within the tournament system 100 where such transactions result in any change in real money, for example, of a balance of a player.

The remote configurations 316 store data for remote configurations of a game based on a remote configurable feature as discussed before.

The game parameters 318 store data for parameters of a game which can vary depending on the game's design.

The matchmaking data 320 stores data related to players that are waiting to match games, and information related to skill thresholds.

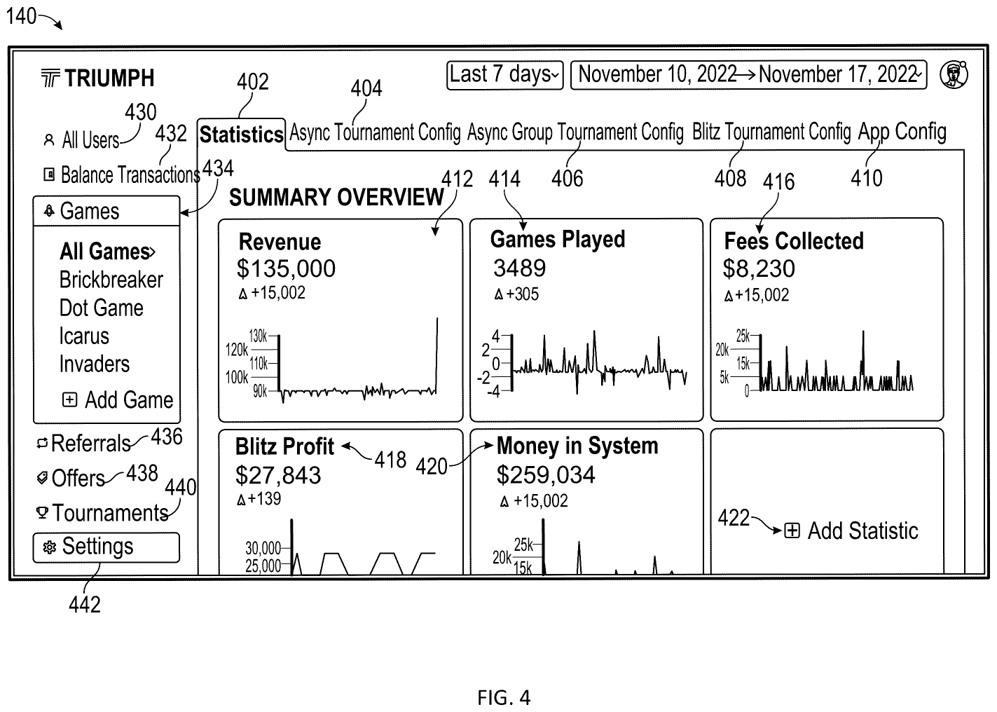

FIG. 4 illustrates an example of an interface corresponding to the dashboard interface 140 that is provided for display on a client device (e.g., the administrator client device 136), in accordance with some embodiments of the subject technology.

As illustrated, the dashboard interface 140 includes various graphical items and graphical areas. For example, the dashboard interface 140 includes a selectable graphical item 402 (“statistics”), a selectable graphical item 404 (“async tournament config”), a selectable graphical item 406 (“asynch group tournament config”), a selectable graphical item 408 (“blitz tournament config”), and a selectable graphical item 410 (“app config”). Each of the aforementioned graphical items 402-410, when selected, corresponds to a tab interface (or tab window) that will be provided for display in the dashboard interface 140 in this example, where each tab interface can function independently from another tab interface.

In the example of FIG. 4, the tab interface corresponding to the selectable graphical item 402 includes a graphical area 412 (“revenue”), a graphical area 414 (“games played”), a graphical area 416 (“fees collected”), a graphical area 418 (“blitz profit”), and a graphical area 420 (“money in system”). Further, this tab interface includes a selectable graphical item 422, which when selected (e.g., using an input cursor, touch input, key stroke(s), and the like) enables the dashboard interface 140 to include an additional graphical area (e.g., related to different information such as a different statistic).

In addition, the dashboard interface 140 includes various graphical items and areas including selectable a graphical item 430 (“all users”), a selectable graphical item 432 (“balance transactions”), a graphical area 434 (“games”), a selectable graphical item 436 (“referrals”), a selectable graphical item 438 (“offers”), a selectable graphical item 440 (“tournaments”), and a selectable graphical item 442 (“settings”).

As further shown, the graphical area 434 includes various graphical items including a listing of different games provided by the tournament system 100. Moreover, a selectable graphical item is provided below the listing of games to facilitate adding a new game to the tournament system 100.

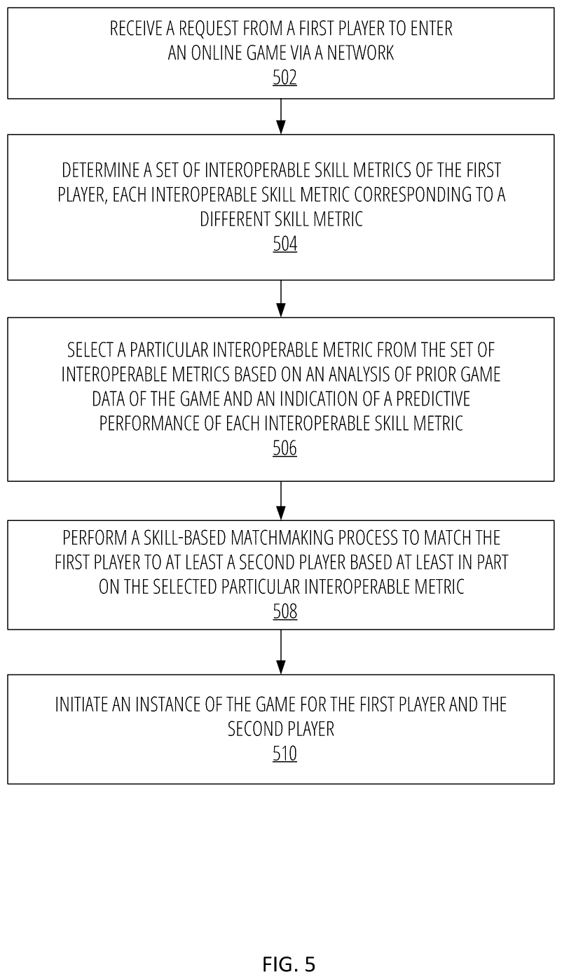

FIG. 5 is a flowchart illustrating a method, according to certain example embodiments. The method may be embodied in computer-readable instructions for execution by one or more computer processors such that the operations of the method may be performed in part or in whole by the backend server 122. However, it shall be appreciated that at least some of the operations of the method may be deployed on various other hardware configurations (e.g., the player client device 102) and the method is not intended to be limited to the backend server 122 or any components or systems mentioned above.

At operation 502, the backend server 122 receives a request from a first player to enter a game.

At operation 504, the backend server 122 determines a set of interoperable skill metrics of the first player, each interoperable skill metric corresponding to a different skill metric. In an example, the set of interoperable skill metrics provide a set of different algorithmic skill assessment techniques that can be used interchangeably within the matchmaking system, each corresponding to a different mathematical approach for evaluating player skill levels.

In an example, such an interoperable skill metric can include the following: Elo rating system, Bayesian skill rating system, Glicko and Glicko-2, MMR (Matchmaking Rating), performance rating, win-loss ratio, K-D ratio (kills to deaths), and the like.

At operation 506, the backend server 122 selects a particular interoperable metric from the set of interoperable skill metrics based on an analysis of prior game data of the game and an indication of a predictive performance of each interoperable skill metric. Predictive performance may refer to the statistical accuracy of a skill metric in forecasting actual game outcomes, measured through analysis of historical game data including win-loss ratios, score correlations, and the metric's ability to create balanced matches where players have approximately equal probability of winning.

In an example, interoperable skill metrics can be used to predict a player's performance in a competitive game to some extent. Interoperable skill metrics may refer to a set of different algorithmic skill assessment techniques that can be used interchangeably within the matchmaking system based on system configuration, where each metric provides a numerical or functional representation of player skill that can be compared and selected dynamically by the matchmaking engine. Such metrics provide insights into a player's past performance and skill level, which can be indicative of future performance. However, an indication of a predictive performance can be influenced by various factors, which can include the following:
Historical performance: Metrics like Elo Rating, Bayesian skill rating system, and MMR are based on a player's past performance, which can be a strong indicator of future performance in similar competitive environments.
Skill estimation: Glicko and Glicko-2 not only estimate skill but also account for the uncertainty of that estimate, providing a more nuanced prediction of potential performance.
Cross-game applicability: Interoperable metrics allow for predictions across different games or platforms, especially when the games share similar mechanics or skill requirements.
Limitations: Predictions based on these metrics may not account for factors such as recent practice, changes in game meta, or a player's current mental or physical state.
Continuous updates: A player's rating may be updated after each match, allowing for more accurate predictions over time as more data is collected.

At operation 508, the backend server 122 performs a skill-based matchmaking process to match the first player to at least a second player based at least in part on the selected particular interoperable metric.

At operation 510, the backend server 122 initiates an instance of the game for the first player and the second player.

In an embodiment, determining the set of interoperable skill metrics comprises: the backend server 122 determining a first skill metric corresponding to a dollar weighted average score with a discount rate; determining a second skill metric corresponding to a binary weighted Elo metric; determining a third skill metric corresponding to a ladder weighted Elo metric; and performing a fourth skill metric corresponding to a weighted Elo metric.

In an embodiment, the backend server 122 further performs an Elo K factor reduction related to the second skill metric, the third skill metric, or the fourth skill metric.

In an embodiment, selecting the particular interoperable metric from the set of interoperable skill metrics comprises: the backend server 122 determining that the first player has a lower skill level based on a first threshold for a skill level; and selecting a dollar-weighted average score with a discount rate as the particular interoperable metric.

In an embodiment, selecting the particular interoperable metric from the set of interoperable skill metrics comprises: the backend server 122 determining that the first player has a higher skill level based on a first threshold for a skill level; and selecting an Elo-based metric as the particular interoperable metric.

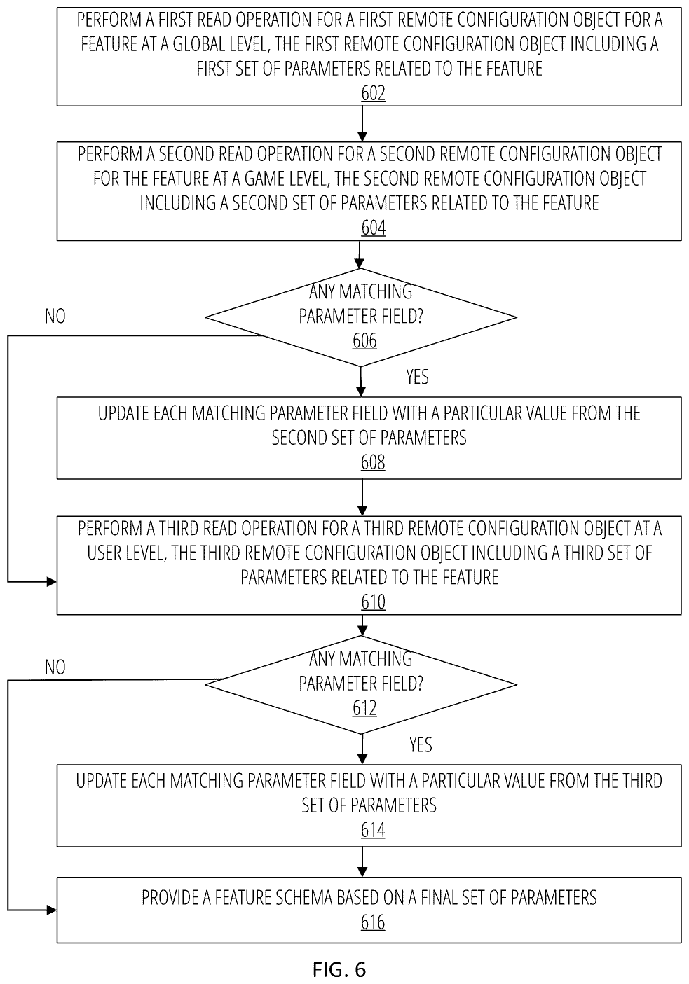

FIG. 6 is a flowchart illustrating a method, according to certain example embodiments. The method may be embodied in computer-readable instructions for execution by one or more computer processors such that the operations of the method may be performed in part or in whole by the backend server 122. However, it shall be appreciated that at least some of the operations of the method may be deployed on various other hardware configurations (e.g., the player client device 102) and the method is not intended to be limited to the backend server 122 or any components or systems mentioned above.

At operation 602, the backend server 122 performs a first read operation for a first remote configuration object for a feature at a global level, the first remote configuration object including a first set of parameters related to the feature.

At operation 604, the backend server 122 performs a second read operation for a second remote configuration object for the feature at a game level, the second remote configuration object including a second set of parameters related to the feature.

At operation 606, the backend server 122 determines whether there are any parameter fields from the second set of features that match any parameter fields in the first set of features. If there is no matching parameter field, the method proceeds to operation 610 discussed below. Alternatively, if there is at least one matching parameter field (e.g., the backend server 122 identifies at least a matching parameter field from the second set of parameters to the first set of parameters), the method continues to operation 608.

At operation 608, the backend server 122 updates each matching parameter field with a particular value from the second set of parameters, each matching parameter field corresponding to a particular parameter from the second set of parameters.

At operation 610, the backend server 122 performs a third read operation for a third remote configuration object for the feature at a user level, the third remote configuration object including a third set of parameters related to the feature.

At operation 612, backend server 122 determines whether there are any matching parameter fields from the second set of features to the first set of features. If there is no matching parameter field, the method proceeds to operation 616 discussed below. Alternatively, if there is at least one matching parameter field (e.g., the backend server 122 identifies at least a matching parameter field from the third set of parameters to the second set of parameters), the method continues to operation 614.

At operation 614, the backend server 122 updates each matching parameter field with a particular value from the third set of parameters, each matching parameter field corresponding to a particular parameter from the third set of parameters.

At operation 616, the backend server 122 provides a feature schema based on a final set of parameters, the final set of parameters including a set of updated values of parameters from the third read operation and the second read operation. In an embodiment, the features schema comprises a set of fields corresponding to a unique identifier, a version, disabling the feature, and metadata related to parameters for the feature. The feature schema enables real-time system configuration changes without requiring software updates (which can be disruptive to the matchmaking process) in an example. Thus, it is understood that, in an example, a given feature schema can include a standardized set of fields including, but not limited, to the following: (1) a unique identifier for the feature, (2) a version number indicating the configuration version to use, (3) a boolean flag for enabling or disabling the feature, and (4) metadata containing feature-specific parameters such as threshold values, metric selections, and operational constraints.

In view of the disclosure above, various examples are set forth below. It should be noted that one or more features of an example, taken in isolation or combination, should be considered within the disclosure of this application.

Example 1 is a system comprising: at least one hardware processor; and a memory storing instructions that cause the at least one hardware processor to perform operations comprising: receiving a request from a first player to enter an online game via a network; determining a set of interoperable skill metrics of the first player, each interoperable skill metric corresponding to a different skill metric; selecting a particular interoperable metric from the set of interoperable skill metrics based on an analysis of prior game data of the online game and an indication of a predictive performance of each interoperable skill metric; performing a skill-based matchmaking process to match the first player to at least a second player based at least in part on the selected particular interoperable metric; and initiating an instance of the online game for the first player and the second player.

Example 2 includes the subject matter of Example 1 wherein determining the set of interoperable skill metrics comprises: determining a first skill metric corresponding to a dollar-weighted average score with a discount rate; determining a second skill metric corresponding to a binary-weighted Elo metric; determining a third skill metric corresponding to a ladder-weighted Elo metric; and performing a fourth skill metric corresponding to a weighted Elo metric.

Example 3 includes the subject matter of any one of Examples 1 and 2, wherein the operations further comprise: performing an Elo K-factor reduction related to the second skill metric, the third skill metric, or the fourth skill metric.

Example 4 includes the subject matter of any one of Examples 1-3, wherein selecting the particular interoperable metric from the set of interoperable skill metrics comprises: determining that the first player has a lower skill level based on a first threshold for a skill level; and selecting a dollar-weighted average score with a discount rate as the particular interoperable metric.

Example 5 includes the subject matter of any one of Examples 1-4, wherein selecting the particular interoperable metric from the set of interoperable skill metrics comprises: determining that the first player has a higher skill level based on a first threshold for a skill level; and selecting an Elo-based metric as the particular interoperable metric.

Example 6 includes the subject matter of any one of Examples 1-5, wherein the operations further comprise: performing a first read operation for a first remote configuration object for a feature at a global level, the first remote configuration object including a first set of parameters related to the feature; performing a second read operation for a second remote configuration object for the feature at a game level, the second remote configuration object including a second set of parameters related to the feature; identifying at least a matching parameter field from the second set of parameters to the first set of parameters; and updating each matching parameter field with a particular value from the second set of parameters, each matching parameter field corresponding to a particular parameter from the second set of parameters.

Example 7 includes the subject matter of any one of Examples 1-6, wherein the operations further comprise: performing a third read operation for a third remote configuration object for the feature at a user level, the third remote configuration object including a third set of parameters related to the feature; identifying at least a matching parameter field from the third set of parameters to the second set of parameters; and updating each matching parameter field with a particular value from the third set of parameters, each matching parameter field corresponding to a particular parameter from the third set of parameters.

Example 8 includes the subject matter of any one of Examples 1-7 wherein the operations further comprise: providing a feature schema based on a final set of parameters, the final set of parameters including a set of updated values of parameters from the third read operation and the second read operation.

Example 9 includes the subject matter of any one of Examples 1-8 wherein the feature schema comprises a set of fields corresponding to a unique identifier, a version, disabling the feature, and metadata related to parameters for the feature.

Example 10 includes the subject matter of any one of Examples 1-9 wherein the instance of the online game for the first player and the second player comprises an online competitive game that requires a buy-in amount to participate.

Example 11 is computerized method comprising: receiving a request from a first player to enter an online game via a network; determining a set of interoperable skill metrics of the first player, each interoperable skill metric corresponding to a different skill metric; selecting a particular interoperable metric from the set of interoperable skill metrics based on an analysis of prior game data of the online game and an indication of a predictive performance of each interoperable skill metric; performing a skill-based matchmaking process to match the first player to at least a second player based at least in part on the selected particular interoperable metric; and initiating an instance of the online game for the first player and the second player.

Example 12 includes the subject matter of Example 11, wherein determining the set of interoperable skill metrics comprises: determining a first skill metric corresponding to a dollar-weighted average score with a discount rate; determining a second skill metric corresponding to a binary-weighted Elo metric; determining a third skill metric corresponding to a ladder-weighted Elo metric; and performing a fourth skill metric corresponding to a weighted Elo metric.

Example 13 includes the subject matter of any one of Examples 11-12, further comprising: performing an Elo K-factor reduction related to the second skill metric, the third skill metric, or the fourth skill metric.

Example 14 includes the subject matter of any one of Examples 11-13, wherein selecting the particular interoperable metric from the set of interoperable skill metrics comprises: determining that the first player has a lower skill level based on a first threshold for a skill level; and selecting a dollar-weighted average score with a discount rate as the particular interoperable metric.

Example 15 includes the subject matter of any one of Examples 11-14, wherein selecting the particular interoperable metric from the set of interoperable skill metrics comprises: determining that the first player has a higher skill level based on a first threshold for a skill level; and selecting an Elo-based metric as the particular interoperable metric.

Example 16 includes the subject matter of any one of 11-15, further comprising: performing a first read operation for a first remote configuration object for a feature at a global level, the first remote configuration object including a first set of parameters related to the feature; performing a second read operation for a second remote configuration object for the feature at a game level, the second remote configuration object including a second set of parameters related to the feature; identifying at least a matching parameter field from the second set of parameters to the first set of parameters; and updating each matching parameter field with a particular value from the second set of parameters, each matching parameter field corresponding to a particular parameter from the second set of parameters.

Example 17 includes the subject matter of any one of 11-16, further comprising: performing a third read operation for a third remote configuration object for the feature at a user level, the third remote configuration object including a third set of parameters related to the feature; identifying at least a matching parameter field from the third set of parameters to the second set of parameters; and updating each matching parameter field with a particular value from the third set of parameters, each matching parameter field corresponding to a particular parameter from the third set of parameters.

Example 18 includes the subject matter of any one of 11-17, further comprising: providing a feature schema based a final set of parameters, the final set of parameters including a set of updated values of parameters from the third read operation and the second read operation.

Example 19 includes the subject matter of any one of 11-18 wherein the feature schema comprises a set of fields corresponding to a unique identifier, a version, disabling the feature, and metadata related to parameters for the feature.

Example 20 is non-transitory computer-storage medium comprising instructions that, when executed by one or more processors of a machine, configure the machine to perform operations comprising: receiving a request from a first player to enter an online game; determining a set of interoperable skill metrics of the first player, each interoperable skill metric corresponding to a different skill metric; selecting a particular interoperable metric from the set of interoperable skill metrics based on an analysis of prior game data of the online game and an indication of a predictive performance of each interoperable skill metric; performing a skill-based matchmaking process to match the first player to at least a second player based at least in part on the selected particular interoperable metric; and initiating an instance of the online game for the first player and the second player.

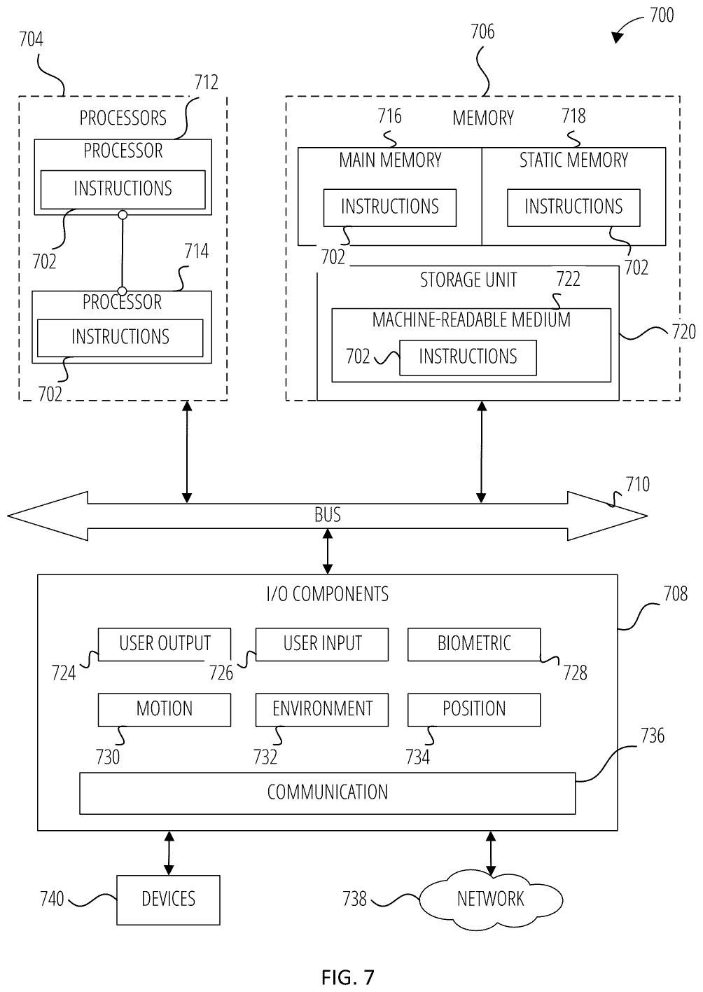

FIG. 7 is a diagrammatic representation of a machine 700 within which instructions 702 (e.g., software, a program, an application, an applet, an app, or other executable code) for causing the machine 700 to perform any one or more of the methodologies discussed herein may be executed. For example, the instructions 702 may cause the machine 700 to execute any one or more of the methods described herein. The instructions 702 transform the general, non-programmed machine 700 into a particular machine 700 programmed to carry out the described and illustrated functions in the manner described.

The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 702, sequentially or otherwise, that specify actions to be taken by the machine 700. Further, while a single machine 700 is illustrated, the term “machine” shall also be taken to include a collection of machines that individually or jointly execute the instructions 702 to perform any one or more of the methodologies discussed herein. The machine 700, for example, may comprise the player client device 102, administrator client device 136 or any one of multiple server devices forming part of the skill-based matchmaking system 110. In some examples, the machine 700 may also comprise both client and server systems, with certain operations of a particular method or algorithm being performed on the server-side and with certain operations of the particular method or algorithm being performed on the client-side.

The machine 700 may include processors 704, memory 706, and input/output I/O components 708, which may be configured to communicate with each other via a bus 710. In an example, the processors 704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 712 and a processor 714 that execute the instructions 702. The term “processor” is intended to include multi-core processors that may comprise two or more independent processors (sometimes referred to as “cores”) that may execute instructions contemporaneously. Although FIG. 7 shows multiple processors 704, the machine 700 may include a single processor with a single-core, a single processor with multiple cores (e.g., a multi-core processor), multiple processors with a single core, multiple processors with multiples cores, or any combination thereof.

The memory 706 includes a main memory 716, a static memory 718, and a storage unit 720, both accessible to the processors 704 via the bus 710. The main memory 706, the static memory 718, and storage unit 720 store the instructions 702 embodying any one or more of the methodologies or functions described herein. The instructions 702 may also reside, completely or partially, within the main memory 716, within the static memory 718, within machine-readable medium 722 within the storage unit 720, within at least one of the processors 704 (e.g., within the processor's cache memory), or any suitable combination thereof, during execution thereof by the machine 700.

The I/O components 708 may include a wide variety of components to receive input, provide output, produce output, transmit information, exchange information, capture measurements, and so on. The specific I/O components 708 that are included in a particular machine will depend on the type of machine. For example, portable machines such as mobile phones may include a touch input device or other such input mechanisms, while a headless server machine will likely not include such a touch input device. It will be appreciated that the I/O components 708 may include many other components that are not shown in FIG. 7. In various examples, the I/O components 708 may include user output components 724 and user input components 726. The user output components 724 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 726 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 708 may include biometric components 728, motion components 730, environmental components 732, or position components 734, among a wide array of other components. For example, the biometric components 728 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 730 include acceleration sensor components (e.g., accelerometer), gravitation sensor components, rotation sensor components (e.g., gyroscope).

The environmental components 732 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the player client device 102 may have a camera system comprising, for example, front cameras on a front surface of the player client device 102 and rear cameras on a rear surface of the player client device 102. The front cameras may, for example, be used to capture still images and video of a user of the player client device 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the player client device 102 may also include a 360° camera for capturing 360° photographs and videos.

Further, the camera system of the player client device 102 may include dual rear cameras (e.g., a primary camera as well as a depth-sensing camera), or even triple, quad or penta rear camera configurations on the front and rear sides of the player client device 102. These multiple cameras systems may include a wide camera, an ultra-wide camera, a telephoto camera, a macro camera, and a depth sensor, for example.

The position components 734 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 708 further include communication components 736 operable to couple the machine 700 to a network 738 or devices 740 via respective coupling or connections. For example, the communication components 736 may include a network interface component or another suitable device to interface with the network 738. In further examples, the communication components 736 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 740 may be another machine or any of a wide variety of peripheral devices (e.g., a peripheral device coupled via a USB).

Moreover, the communication components 736 may detect identifiers or include components operable to detect identifiers. For example, the communication components 736 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 736, such as location via Internet Protocol (IP) geolocation, location via Wi-Fi® signal triangulation, location via detecting an NFC beacon signal that may indicate a particular location, and so forth.

The various memories (e.g., main memory 716, static memory 718, and memory of the processors 704) and storage unit 720 may store one or more sets of instructions and data structures (e.g., software) embodying or used by any one or more of the methodologies or functions described herein. These instructions (e.g., the instructions 702), when executed by processors 704, cause various operations to implement the disclosed examples.

The instructions 702 may be transmitted or received over the network 738, using a transmission medium, via a network interface device (e.g., a network interface component included in the communication components 736) and using any one of several well-known transfer protocols (e.g., hypertext transfer protocol (HTTP)). Similarly, the instructions 702 may be transmitted or received using a transmission medium via a coupling (e.g., a peer-to-peer coupling) to the devices 740.

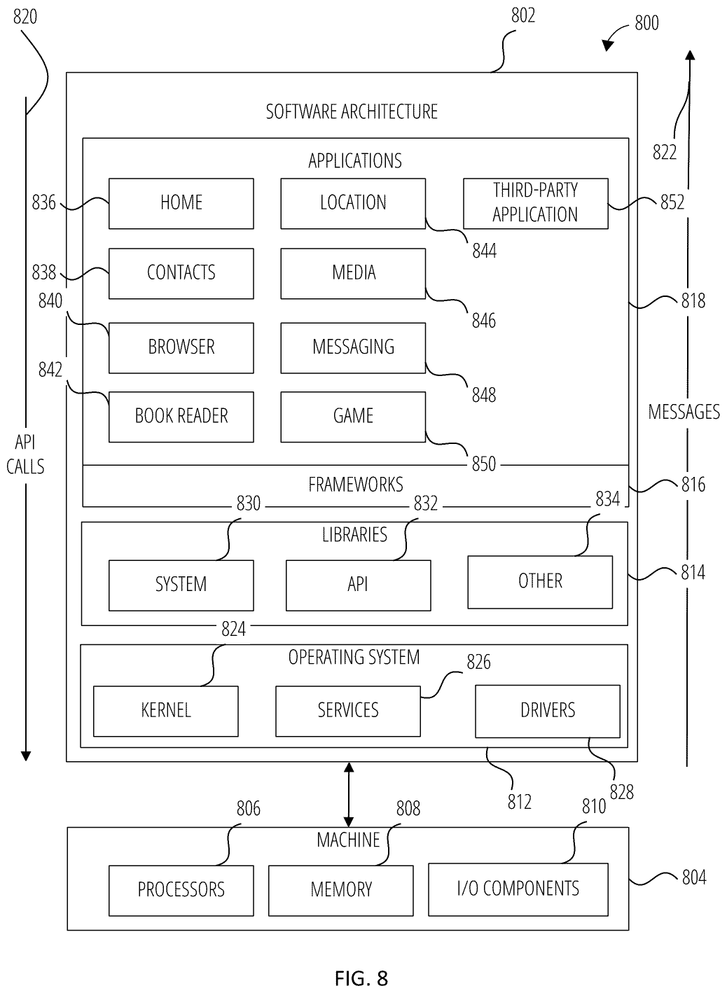

FIG. 8 is a block diagram 800 illustrating a software architecture 802, which can be installed on any one or more of the devices described herein. The software architecture 802 is supported by hardware such as a machine 804 that includes processors 806, memory 808, and I/O components 810. In this example, the software architecture 802 can be conceptualized as a stack of layers, where each layer provides a particular functionality. The software architecture 802 includes layers such as an operating system 812, libraries 814, frameworks 816, and applications 818. Operationally, the applications 818 invoke API calls 820 through the software stack and receive messages 822 in response to the API calls 820.

The operating system 812 manages hardware resources and provides common services. The operating system 812 includes, for example, a kernel 824, services 826, and drivers 828. The kernel 824 acts as an abstraction layer between the hardware and the other software layers. For example, the kernel 824 provides memory management, processor management (e.g., scheduling), component management, networking, and security settings, among other functionalities. The services 826 can provide other common services for the other software layers. The drivers 828 are responsible for controlling or interfacing with the underlying hardware. For instance, the drivers 828 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 814 provide a common low-level infrastructure used by the applications 818. The libraries 814 can include system libraries 830 (e.g., C standard library) that provide functions such as memory allocation functions, string manipulation functions, mathematic functions, and the like. In addition, the libraries 814 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 814 can also include a wide variety of other libraries 834 to provide many other APIs to the applications 818.

The frameworks 816 provide a common high-level infrastructure that is used by the applications 818. For example, the frameworks 816 provide various graphical user interface (GUI) functions, high-level resource management, and high-level location services. The frameworks 816 can provide a broad spectrum of other APIs that can be used by the applications 818, some of which may be specific to a particular operating system or platform.

In an example, the applications 818 may include a home application 836, a contacts application 838, a browser application 840, a book reader application 842, a location application 844, a media application 846, a messaging application 848, a game application 850, and a broad assortment of other applications such as a third-party application 852. The applications 818 are programs that execute functions defined in the programs. Various programming languages can be employed to create one or more of the applications 818, structured in a variety of manners, such as object-oriented programming languages (e.g., Objective-C, Java, or C++) or procedural programming languages (e.g., C or assembly language). In a specific example, the third-party application 852 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 852 can invoke the API calls 820 provided by the operating system 812 to facilitate functionalities described herein.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations.

A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein.

Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled.

Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

What is claimed is:

1. A system comprising:
at least one hardware processor; and
a memory storing instructions that cause the at least one hardware processor to perform operations comprising:
receiving a request from a first player to enter an online game via a network;
determining a set of interoperable skill metrics of the first player, each interoperable skill metric corresponding to a different skill metric;
selecting a particular interoperable metric from the set of interoperable skill metrics based on an analysis of prior game data of the online game and an indication of a predictive performance of each interoperable skill metric;
performing a skill-based matchmaking process to match the first player to at least a second player based at least in part on the selected particular interoperable metric; and
initiating an instance of the online game for the first player and the second player.

2. The system of claim 1, wherein determining the set of interoperable skill metrics comprises:
determining a first skill metric corresponding to a dollar-weighted average score with a discount rate;
determining a second skill metric corresponding to a binary-weighted Elo metric;
determining a third skill metric corresponding to a ladder-weighted Elo metric; and
performing a fourth skill metric corresponding to a weighted Elo metric.

3. The system of claim 2, wherein the operations further comprise:
performing an Elo K-factor reduction related to the second skill metric, the third skill metric, or the fourth skill metric.

4. The system of claim 1, wherein selecting the particular interoperable metric from the set of interoperable skill metrics comprises:
determining that the first player has a lower skill level based on a first threshold for a skill level; and
selecting a dollar-weighted average score with a discount rate as the particular interoperable metric.

5. The system of claim 1, wherein selecting the particular interoperable metric from the set of interoperable skill metrics comprises:
determining that the first player has a higher skill level based on a first threshold for a skill level; and
selecting an Elo-based metric as the particular interoperable metric.

6. The system of claim 1, wherein the operations further comprise:
performing a first read operation for a first remote configuration object for a feature at a global level, the first remote configuration object including a first set of parameters related to the feature;
performing a second read operation for a second remote configuration object for the feature at a game level, the second remote configuration object including a second set of parameters related to the feature;
identifying at least a matching parameter field from the second set of parameters to the first set of parameters; and
updating each matching parameter field with a particular value from the second set of parameters, each matching parameter field corresponding to a particular parameter from the second set of parameters.

7. The system of claim 6, wherein the operations further comprise:
performing a third read operation for a third remote configuration object for the feature at a user level, the third remote configuration object including a third set of parameters related to the feature;
identifying at least a matching parameter field from the third set of parameters to the second set of parameters; and
updating each matching parameter field with a particular value from the third set of parameters, each matching parameter field corresponding to a particular parameter from the third set of parameters.

8. The system of claim 7, wherein the operations further comprise:
providing a feature schema based on a final set of parameters, the final set of parameters including a set of updated values of parameters from the third read operation and the second read operation.

9. The system of claim 8, wherein the feature schema comprises a set of fields corresponding to a unique identifier, a version, disabling the feature, and metadata related to parameters for the feature.

10. The system of claim 1, wherein the instance of the online game for the first player and the second player comprises an online competitive game that requires a buy-in amount to participate.

11. A computerized method comprising:
receiving a request from a first player to enter an online game via a network;
determining a set of interoperable skill metrics of the first player, each interoperable skill metric corresponding to a different skill metric;
selecting a particular interoperable metric from the set of interoperable skill metrics based on an analysis of prior game data of the online game and an indication of a predictive performance of each interoperable skill metric;
performing a skill-based matchmaking process to match the first player to at least a second player based at least in part on the selected particular interoperable metric; and
initiating an instance of the online game for the first player and the second player.

12. The computerized method of claim 11, wherein determining the set of interoperable skill metrics comprises:
determining a first skill metric corresponding to a dollar-weighted average score with a discount rate;
determining a second skill metric corresponding to a binary-weighted Elo metric;
determining a third skill metric corresponding to a ladder-weighted Elo metric; and
performing a fourth skill metric corresponding to a weighted Elo metric.

13. The computerized method of claim 12, further comprising:
performing an Elo K-factor reduction related to the second skill metric, the third skill metric, or the fourth skill metric.

14. The computerized method of claim 11, wherein selecting the particular interoperable metric from the set of interoperable skill metrics comprises:
determining that the first player has a lower skill level based on a first threshold for a skill level; and
selecting a dollar-weighted average score with a discount rate as the particular interoperable metric.

15. The computerized method of claim 11, wherein selecting the particular interoperable metric from the set of interoperable skill metrics comprises:
determining that the first player has a higher skill level based on a first threshold for a skill level; and
selecting an Elo-based metric as the particular interoperable metric.

16. The computerized method of claim 11, further comprising:
performing a first read operation for a first remote configuration object for a feature at a global level, the first remote configuration object including a first set of parameters related to the feature;
performing a second read operation for a second remote configuration object for the feature at a game level, the second remote configuration object including a second set of parameters related to the feature;
identifying at least a matching parameter field from the second set of parameters to the first set of parameters; and
updating each matching parameter field with a particular value from the second set of parameters, each matching parameter field corresponding to a particular parameter from the second set of parameters.

17. The computerized method of claim 16, further comprising:
performing a third read operation for a third remote configuration object for the feature at a user level, the third remote configuration object including a third set of parameters related to the feature;
identifying at least a matching parameter field from the third set of parameters to the second set of parameters; and
updating each matching parameter field with a particular value from the third set of parameters, each matching parameter field corresponding to a particular parameter from the third set of parameters.

18. The computerized method of claim 17, further comprising:
providing a feature schema based a final set of parameters, the final set of parameters including a set of updated values of parameters from the third read operation and the second read operation.

19. The computerized method of claim 18, wherein the feature schema comprises a set of fields corresponding to a unique identifier, a version, disabling the feature, and metadata related to parameters for the feature.

20. A non-transitory computer-storage medium comprising instructions that, when executed by one or more processors of a machine, configure the machine to perform operations comprising:
receiving a request from a first player to enter an online game;
determining a set of interoperable skill metrics of the first player, each interoperable skill metric corresponding to a different skill metric;
selecting a particular interoperable metric from the set of interoperable skill metrics based on an analysis of prior game data of the online game and an indication of a predictive performance of each interoperable skill metric;
performing a skill-based matchmaking process to match the first player to at least a second player based at least in part on the selected particular interoperable metric; and
initiating an instance of the online game for the first player and the second player.
